(19) United States
(12) Patent Application Publication
(10) Pub. No.: US 2026/0259059 A1
(43) Pub. Date: Sep. 3, 2026

(54) METHODS AND SYSTEMS FOR GENERATING A HIGH-DEFINITION MAP USING A KNOWLEDGE-ENHANCED GRAPH-TRANSFORMER NETWORK

(71) Applicant: Huawei Technologies Co., Ltd., Shenzhen (CN)

(72) Inventors: Zhanguang Zhang, Brossard (CA); Lingfeng Zhang, Montreal (CA); Yingxue Zhang, Markham (CA)

(21) Appl. No.: 19/067,523

(22) Filed: Feb. 28, 2025

(51) Int. Cl. G01C 21/00; B60W 60/00; G06N 3/0455; G06N 7/01

(52) U.S. Cl. CPC G01C 21/3815; B60W 60/001; G01C 21/3844; G06N 3/0455; G06N 7/01; B60W 2556/40

(57) ABSTRACT

There are provided methods and systems for generating a high-definition (HD) map of a vehicle's surrounding environment at runtime. Road topology data corresponding to the vehicle environment along with a set of defined rules for interactions between road elements in the vehicle environment are obtained. Instance information corresponding to object instances in the vehicle environment are received from one or more vehicle sensors. An initial graph representation of the vehicle environment is generated based on the road topology data, the set of defined rules and instance features extracted from the instance information. A HD map of the vehicle environment is generated based on the instance features and the initial graph representation. The disclosed methods and systems may incorporate prior knowledge about a vehicle environment into a transformer-based graph neural network (GNN) framework, for enabling improved online HD map generation.

### FIELD

The present disclosure relates to the field of machine learning, in particular, to transformer-based graph neural networks (GNN), and more specifically, to methods and systems for generating a high-definition map using a knowledge-enhanced graph-transformer network.

### BACKGROUND

Autonomous vehicles (i.e. self-driving cars) include an autonomous driving system (ADS) that controls autonomous operation of the autonomous vehicle in an environment. An autonomous vehicle includes different types of environment sensors (e.g. cameras, such as optical cameras, and detection and ranging sensors, such a light detection and ranging (LIDAR) sensors, etc.) mounted to the autonomous vehicle which sense the environment surrounding the autonomous vehicle. The ADS of the autonomous vehicle includes subsystems that process environmental sensor data received from the different types of sensors, to enable vehicles to sense the environment, make decisions and control vehicle components, for example, to navigate roads in accordance with a planned path, obey traffic laws, and avoid obstacles.

An ADS may use a high-definition (HD) map to perform various tasks for the autonomous vehicle, such as vehicle localization, path planning, motion planning, and trajectory generation. HD maps provide highly detailed and precise representation of an environment of the vehicle (e.g., at the centimeter level). Due to the size and/or complexity of HD maps, online HD map generation and processing (e.g., at runtime, using onboard vehicle sensors) may be limited by available computing resources associated with the vehicle.

Accordingly, improvements in the online HD map generation for use in controlling actions of an autonomous vehicle are desired.

### SUMMARY

In various examples, the present disclosure describes methods and systems for generating a high-definition (HD) map of a vehicle's surrounding environment at runtime. Road topology data corresponding to the vehicle environment along with a set of defined rules for interactions between road elements in the vehicle environment are obtained. Instance information corresponding to object instances in the vehicle environment are received from one or more vehicle sensors. An initial graph representation of the vehicle environment is generated based on the road topology data, the set of defined rules and instance features extracted from the instance information. A HD map of the vehicle environment is generated based on the instance features and the initial graph representation. The disclosed methods and systems may incorporate prior knowledge about a vehicle environment and/or object relationships within the environment, into a graph-transformer framework, for enabling improved online HD map generation.

In various examples, the present disclosure provides the technical effect that a HD map representing an environment of an ego-vehicle is generated at runtime. HD maps are high-precision maps used by an autonomous driving system for enabling accurate navigation. While HD maps are a critical part of modern autonomous driving system, conventional offline HD map creation and maintenance are expensive and resource-intensive, thereby limiting their scalability and deployment. For example, HD maps are generally created offline using specialized surveying techniques, LiDAR and other sensor data to achieve the desired accuracy and precision. Furthermore, processing HD maps when performing a task for an autonomous vehicle typically requires considerable computing resources (e.g., processing power, memory etc.). in this regard, generating a HD map at runtime using knowledge-based inputs (e.g., SD maps, defined rules etc.) in combination with data-based inputs helps to reduce the overall computational load associated with using pre-generated (e.g., offline) HD maps for autonomous driving tasks.

Advantageously, the online HD map generation system of the present disclosure combines a knowledge-driven GNN channel with a data-driven transformer channel within a knowledge-enhanced graph-transformer network, thereby incorporating the benefits associated with both GNN and transformer-based approaches for online HD map generation. Current approaches for online HD map generation rely on transformer-based methods, which require large amounts of data to train and which lack the ability to introduce prior knowledge (e.g., obtained from static SD maps or other known relationships within a vehicle environment) as an input, which have been shown to be effective for map reconstruction. Furthermore, adding a knowledge-based channel helps to reduce the dependency on large amounts of training data while improving the overall accuracy of the reconstructed HD map.

In an example aspect, the present disclosure describes a computer-implemented method for generating a high-definition (HD) map. The method includes: obtaining road topology data corresponding to a vehicle environment, and a set of defined rules for interactions between road elements in the vehicle environment; receiving, from one or more vehicle sensors, instance information corresponding to object instances in the vehicle environment; generating an initial graph representation of the vehicle environment, based on the road topology data, the set of defined rules and instance features extracted from the instance information; and generating a high-definition (HD) map of the vehicle environment, based on the instance features and the initial graph representation.

In an example of the preceding example aspect of the method, wherein generating the HD map comprises: encoding, by an encoder subnetwork, the instance features, to generate instance embeddings; generating, by a hybrid graph neural network (GNN)-transformer framework, a set of fused embeddings, based on the instance embeddings and the initial graph representation; and decoding the fused embeddings to generate the HD map.

In an example of a preceding example aspect of the method, wherein generating the set of fused embeddings comprises: processing, by a graph neural network (GNN), the initial graph representation to generate initial graph embeddings; processing, by a transformer subnetwork, the instance embeddings to generate updated instance embeddings; and generating the fused embeddings, based on the initial graph embeddings and the updated instance embeddings.

In an example of a preceding example aspect of the method, wherein generating the set of fused embeddings comprises: processing, by a graph neural network (GNN), the initial graph representation and the instance embeddings to generate updated instance embeddings; and processing, by a transformer subnetwork, the updated instance embeddings to generate the fused embeddings.

In an example of a preceding example aspect of the method, wherein generating the set of fused embeddings comprises: processing, by a transformer subnetwork, the instance embeddings to generate updated instance embeddings; and processing, by a graph neural network (GNN), the updated instance embeddings and the initial graph representation, to generate the fused embeddings.

In an example of a preceding example aspect of the method, wherein the GNN-transformer framework includes a relational graph convolutional network (RGCN) and a transformer subnetwork including an attention mechanism.

In an example of a preceding example aspect of the method, wherein generating the initial graph representation comprises: assembling a graph network comprising a plurality of nodes and a plurality of edges connecting the nodes, wherein each node in the graph network corresponds to a respective instance in the vehicle environment and each edge in the graph network represents a relationship between two associated nodes that are connected by the edge.

In an example of the preceding example aspect of the method, further comprising: modeling a probability distribution of road topology in the road topology data, using a Bayesian probabilistic model; and assembling the graph network, based on the probability distribution.

In an example of a preceding example aspect of the method, wherein the road topology data includes a standard definition map of the vehicle environment.

In an example of a preceding example aspect of the method, further comprising: providing the HD map to a controller of an autonomous vehicle, to cause the controller to automatically control an action of the autonomous vehicle, based on the HD map.

In an example aspect, the present disclosure describes a system including: one or more processors; and a memory storing machine-executable instructions which, when executed by the one or more processors, cause the system to: obtain road topology data corresponding to a vehicle environment, and a set of defined rules for interactions between road elements in the vehicle environment; receive, from one or more vehicle sensors, instance information corresponding to object instances in the vehicle environment; generate an initial graph representation of the vehicle environment, based on the road topology data, the set of defined rules and instance features extracted from the instance information; and generate a high-definition (HD) map of the vehicle environment, based on the instance features and the initial graph representation.

In an example of the preceding example aspect of the system, wherein the machine-executable instructions, when executed by the one or more processors to generate the HD map, further cause the system to: encode, by an encoder subnetwork, the instance features, to generate instance embeddings; generate, by a hybrid graph neural network (GNN)-transformer framework, a set of fused embeddings, based on the instance embeddings and the initial graph representation; and decode the fused embeddings to generate the HD map.

In an example of a preceding example aspect of the system, wherein the machine-executable instructions, when executed by the one or more processors to generate the set of fused embeddings, further cause the system to: process, by a graph neural network (GNN), the initial graph representation to generate initial graph embeddings; process, by a transformer subnetwork, the instance embeddings to generate updated instance embeddings; and generate the fused embeddings, based on the initial graph embeddings and the updated instance embeddings.

In an example of a preceding example aspect of the system, wherein the machine-executable instructions, when executed by the one or more processors to generate the set of fused embeddings, further cause the system to: process, by a graph neural network (GNN), the initial graph representation and the instance embeddings to generate updated instance embeddings; and process, by a transformer subnetwork, the updated instance embeddings to generate the fused embeddings.

In an example of a preceding example aspect of the system, wherein the machine-executable instructions, when executed by the one or more processors to generate the set of fused embeddings, further cause the system to: process, by a transformer subnetwork, the instance embeddings to generate updated instance embeddings; and process, by a graph neural network (GNN), the updated instance embeddings and the initial graph representation, to generate the fused embeddings.

In an example of a preceding example aspect of the system, wherein the GNN-transformer framework includes a relational graph convolutional network (RGCN) and a transformer subnetwork including an attention mechanism.

In an example of a preceding example aspect of the system, wherein the machine-executable instructions, when executed by the one or more processors to generate the initial graph representation, further cause the system to: assemble a graph network comprising a plurality of nodes and a plurality of edges connecting the nodes, wherein each node in the graph network corresponds to a respective instance in the vehicle environment and each edge in the graph network represents a relationship between two associated nodes that are connected by the edge.

In an example of the preceding example aspect of the system, wherein the machine-executable instructions, when executed by the one or more processors, further cause the system to: model a probability distribution of road topology in the road topology data, using a Bayesian probabilistic model; and assemble the graph network, based on the probability distribution.

In an example of a preceding example aspect of the system, wherein the road topology data includes a standard definition map of the vehicle environment.

In some example aspects, the present disclosure describes a non-transitory computer-readable medium having machine-executable instructions stored thereon, the machine-executable instructions, when executed by a processor of a device, cause the device to: obtain road topology data corresponding to a vehicle environment, and a set of defined rules for interactions between road elements in the vehicle environment; receive, from one or more vehicle sensors, instance information corresponding to object instances in the vehicle environment; generate an initial graph representation of the vehicle environment, based on the road topology data, the set of defined rules and instance features extracted from the instance information; and generate a high-definition (HD) map of the vehicle environment, based on the instance features and the initial graph representation.

In some example aspects, the present disclosure describes a non-transitory computer readable medium storing instructions thereon. The instructions, when executed by a processor, cause the processor to perform any of the preceding example aspects of the method.

### BRIEF DESCRIPTION OF THE DRAWINGS

Reference will now be made, by way of example, to the accompanying drawings which show example embodiments of the present application, and in which:

FIG. 1A is a schematic diagram showing an example environment in which an autonomous vehicle operates, in accordance with some embodiments of the present disclosure;

FIG. 1B is a block diagram illustrating some example components of an autonomous vehicle, in accordance with some embodiments of the present disclosure;

FIG. 2 is a block diagram illustrating an example computing system which may be used to implement examples of the present disclosure;

FIG. 3 shows a block diagram of an example architecture for a HD map generation system, in accordance with examples of the present disclosure;

FIG. 4A shows a block diagram of an example architecture for a knowledge-enhanced graph-transformer network, in accordance with an example embodiment of the present disclosure;

FIG. 4B shows a block diagram of an example architecture for a knowledge-enhanced graph-transformer network, in accordance with an example embodiment of the present disclosure;

FIG. 4C shows a block diagram of an example architecture for a knowledge-enhanced graph-transformer network, in accordance with an example embodiment of the present disclosure;

FIG. 5 is a flowchart illustrating an example method for generating a HD map, in accordance with examples of the present disclosure.

Similar reference numerals may have been used in different figures to denote similar components.

### DETAILED DESCRIPTION

The following describes example technical solutions of this disclosure with reference to accompanying figures. To assist in understanding the present disclosure, some concepts relevant to neural networks and machine learning (ML) are first discussed.

Machine learning (ML) is an application of artificial intelligence (AI) that provides systems the ability to automatically learn and improve from experience without being explicitly programmed. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network, for example, an input layer that accepts inputs, an output layer that generates a prediction as output, and in the case of deep neural networks (DNN), a plurality of hidden layers which are situated between the input layer and output layer. The output of one layer may be provided as input to a subsequent layer. Thus, input to a neural network may be processed through a succession of layers until an output of the neural network is generated by a final layer.

A deep neural network (DNN) is a type of neural network having multiple layers and/or a large number of neurons. The term DNN may encompass any neural network having multiple layers, including convolutional neural networks (CNNs), recurrent neural networks (RNNs), graph neural networks (GNN), and multilayer perceptrons (MLPs), among others. DNNs are often used as ML-based models for modelling complex behaviors in order to improve accuracy of outputs (e.g., more accurate predictions) such as, for example, as compared with models with fewer layers. In the present disclosure, the term machine learning model, or simply “ML model” may be understood to refer to a DNN.

Training of the ML model is a process of learning the values of the parameters (or weights) of the neurons in the layers such that the ML model is able to model the target behavior to a desired degree of accuracy. In the process of training a ML model, two approaches are commonly used: supervised learning and unsupervised learning. In unsupervised learning, the neural network is not provided with any information on desired outputs, and the neural network is trained to arrive at a set of learned weights on its own. In supervised learning, a predicted value outputted by the ML model may be compared to a desired target value (e.g., a ground truth value). A weight vector (which is a vector containing the weights W for a given layer) of each layer of the ML model is updated based on a difference between the predicted value and the desired target value or based on some other objective function (e.g., the minimization of a loss function, or the maximization of a reward, among other possibilities). This comparison and adjustment may be carried out iteratively until a convergence condition is met, for example, a predefined maximum number of iterations has been performed, or the value outputted by the ML model is sufficiently converged with the desired target value or objective function, after which the ML model is considered to be sufficiently trained. The values of the learned parameters may then be fixed and the ML model may be deployed to generate output in real-world applications (also referred to as “inference”).

Training typically requires the use of a training dataset, which is a set of data that is relevant to the target behavior of the ML model. The training data may be a subset of a larger data set. For example, a data set may be split into three mutually exclusive subsets: a training set, a validation (or cross-validation) set, and a testing set and the three subsets of data may be used sequentially during ML model training, or other segmentations of the larger data set and/or schemes for using the segments for training one or more ML models are possible. For example, the training set may be first used to train one or more ML models, for example, where each ML model may have unique characteristics, such as a particular architecture, a particular training procedure, being describable by a set of model hyperparameters, etc. The validation (or cross-validation) set may then be used as input data into the trained ML models to measure the performance of the trained ML models and/or compare performance between them. Once such a trained ML model is obtained, output may be generated using the trained ML model based on the third subset (the testing set), for assessing the accuracy of the trained ML model.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Once the ML model is considered to be sufficiently trained, the values of the learned parameters may be fixed and the ML model may be deployed to generate output in real-world applications (also referred to as “inference”). In some examples, a trained ML model may be fine-tuned, meaning that the values of the learned parameters may be adjusted slightly in order for the ML model to better model a specific task. Fine-tuning of a ML model typically involves further training the ML model on a number of data samples that closely target the specific task.

In the present disclosure, a “high-definition (HD) map” can mean: a type of highly-detailed geospatial map used in autonomous driving. In examples, a HD map provides highly accurate and precise (e.g., often with centimeter-level precision) information about important objects and properties of a vehicle environment, such as road geometry (e.g., roads, lane markings etc.), traffic measures (lights, signs, speed limits), buildings, etc. In examples, a HD map may be used in cooperation with a localization system to localize an autonomous vehicle on the map in real-time, thereby assisting with vehicle navigation and path planning.

In the present disclosure, a “standard-definition (SD) map” can mean: a type of map that contains basic information for guiding a vehicle, but with a lower level of detail compared to HD maps.

In the present disclosure, “online HD map generation” can mean: the building or creation of a HD map representing an environment of an ego-vehicle at runtime, using information including data collected via onboard sensors, among other information.

In the present disclosure, “road topology” can mean: road properties and relationships between road elements that are provided in a simplified format. For example, a topological map may provide only vital information about road connections (or connections between road elements), but may lack details such as scale, distance or direction, among other possibilities.

In the present disclosure, “embeddings” can mean: low-dimensional, learned representations of discrete variables as vectors of numeric values. They represent a mapping between discrete variables and a vector of continuous numbers and are learned for neural network models. In some examples, embeddings may be referred to as embedding vectors.

In the present disclosure, “feature fusion” can mean: the consolidation of feature representations (i.e. feature embeddings) from different sources into a single joint feature representation or embedding.

Other terms used in the present disclosure may be introduced and defined in the following description.

Early approaches to HD map construction formulated the task as a segmentation problem, predicting the occupancy of the rasterized grids. However, due to segmentation approaches lacking the necessary geometric details essential for downstream tasks, more recent approaches have focused on learning a vectorized representation which can maintain map topology and geometric attributes. More specifically, current approaches for generating HD maps rely on transformer-based approaches (e.g., incorporating attention-based transformers) for modeling interaction between instances and learning the vectorized representation. For example, such approaches typically include an encoder for processing instance features and generating initial instance embeddings, an attention-based transformer block for capturing interactions across all instance embeddings, and a decoder for processing the outputs of the transformer block (e.g., predicting map elements along with their connections) to generate the HD map.

One example approach that is described in: Li, Qi, et al., “Hdmapnet: An online hd map construction and evaluation framework”, 2022 International Conference on Robotics and Automation (ICRA), IEEE, 2022, the entirety of which is hereby incorporated by reference, generates a vectorized HD map from various rasterized Bird Eye View (BEV) segmentations, followed by a post-processing module. However, the described post-processing module requires extensive customization and is computationally slow. Another example approach that employs a transformer encoder to query map encodings with path features for path-level modeling, is described in: Liao, Bencheng, et al., “Lane graph as path: Continuity-preserving path-wise modeling for online lane graph construction”, European Conference on Computer Vision, Cham: Springer Nature Switzerland, 2024, the entirety of which is hereby incorporated by reference. Another example approach using a hierarchical decoding structure using two-stage transformers is described in: Liu, Yicheng, et al., “Vectormapnet: End-to-end vectorized hd map learning”, International Conference on Machine Learning, PMLR, 2023, the entirety of which is hereby incorporated by reference. Another example approach proposing a hierarchical query embedding scheme to encode instance-level and point-level features is described in: Liao, Bencheng, et al., “Maptr: Structured modeling and learning for online vectorized hd map construction”, arXiv preprint arXiv:2208.14437 (2022), the entirety of which is hereby incorporated by reference. Finally, a recent approach that represents map elements as an instance-level graph (with vertices and edges extracted using CNN models) using an attentional GNN method is described in: Shin, Juyeb, et al., “Instagram: Instance-level graph modeling for vectorized hd map learning”, IEEE Transactions on Intelligent Transportation Systems (2025), the entirety of which is hereby incorporated by reference. However, the described attentional GNN method relies on multi-head self-attention module for global graph embedding interaction, rather than message-passing between neighboring nodes.

In some embodiments, the present disclosure describes examples that address some or all of the above drawbacks of existing techniques for generating HD maps for ego vehicles at runtime.

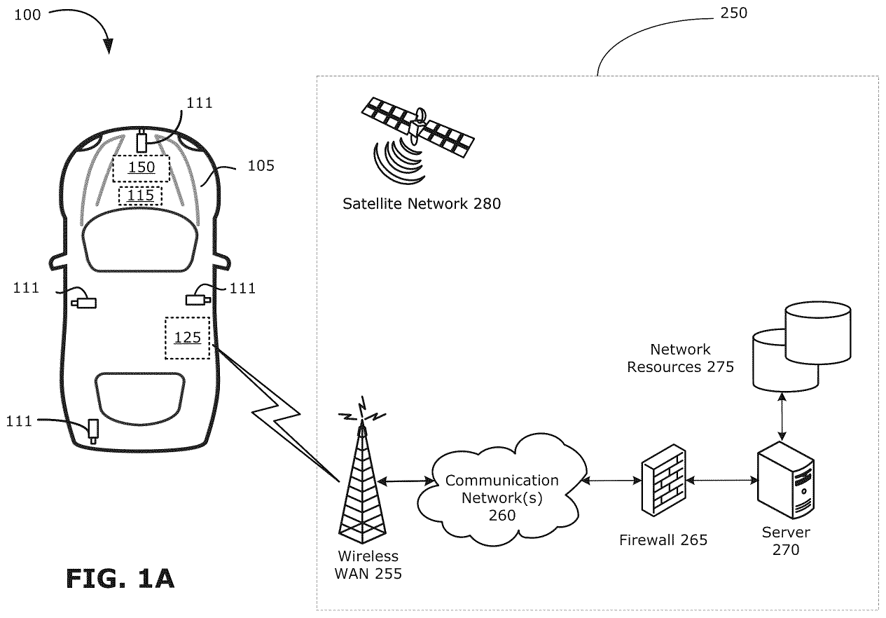

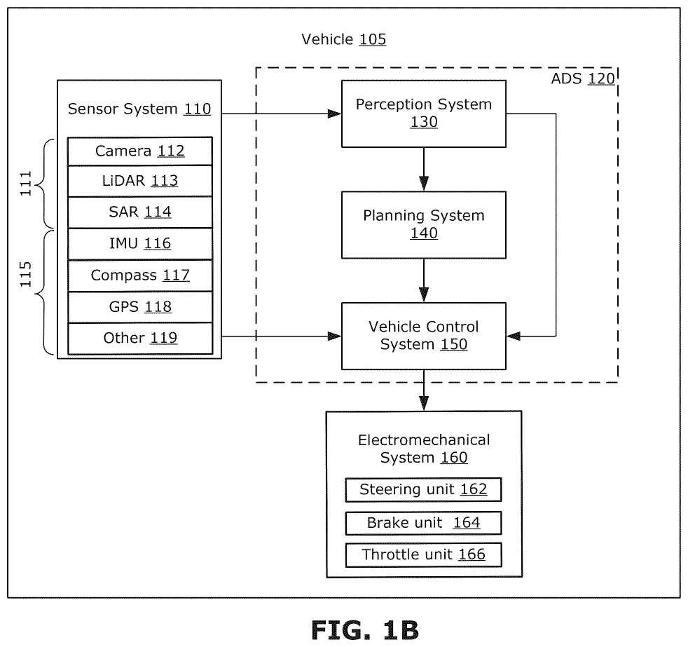

FIG. 1A is a schematic diagram showing an example environment 100 in which a vehicle 105 operates. Examples of the present disclosure may be implemented in the vehicle 105, or in cooperation with a cloud-based system, for example, to enable autonomous or semi-autonomous driving. The environment 100 includes a communication system 250 that communicates with the vehicle 105. The vehicle 105 includes a vehicle control system 150. The vehicle control system 150, is coupled to a drive control system and a mechanical system of the vehicle 105, as described further below with reference to FIG. 1B. The vehicle control system 150 can, in various examples, enable the vehicle 105 to be operable in one or more of a fully-autonomous, semi-autonomous or fully user-controlled mode. In the present disclosure, the vehicle 105 is described in the embodiment of an automobile, such as a car; however, the present disclosure may be implemented in other autonomous vehicles, as discussed above.

The vehicle 105 may include sensors, shown as a plurality of environment sensors 111 that collect information about the external environment 100 surrounding the vehicle 105 and generate sensor data indicative of such information, and a plurality of vehicle sensors 115 that collect information about the operating conditions of the vehicle 105 and generate vehicle data indicative of such information. There may be different types of environment sensors 111 to collect different types of information about the environment 100, as discussed further below with respect to FIG. 1B. In an example embodiment, the environment sensors 111 are mounted to and located at the front, rear, left side and right side of the vehicle 105 to collect information about the external environment 100 located in front, rear, left side and right side of the vehicle 105. For example, individual units of the environment sensors 111 may be mounted or otherwise located on the vehicle 105 to have different overlapping or non-overlapping fields of view (FOVs) or coverage areas to capture data about the environment 100 surrounding the vehicle 105. The vehicle control system 150 receives sensor data indicative of collected information about the external environment 100 of the vehicle 105 as collected by the environment sensors 111.

The vehicle sensors 115 provide vehicle data indicative of collected information about the operating conditions of the vehicle 105 to the vehicle control system 150 in real-time or near real-time. For example, the vehicle control system 150 may determine a linear speed of the vehicle 105, angular speed of the vehicle 105, acceleration of the vehicle 105, engine RPMs of the vehicle 105, transmission gear and tire grip of the vehicle 105, among other factors, using vehicle data indicative of information about the operating conditions of the vehicle 105 provided by one or more of the vehicle sensors 115.

The vehicle control system 150 includes one or more wireless transceivers 125 or may be coupled to one or more wireless transceivers 125 that enable the vehicle control system 150 to communicate with the communication system 250. The one or more wireless transceivers 125 enable the vehicle control system 150 to communicate with the communication system 250. For example, the wireless transceiver(s) 125 may include one or more cellular (RF) transceivers for communicating with a plurality of different radio access networks (e.g., cellular networks) or other vehicles in the environment using different wireless data communication protocols and standards. The wireless transceiver(s) 125 may communicate with any one of a plurality of fixed transceiver base stations of a wireless wide area network (WAN) 255 (e.g., cellular network) within its geographic coverage area. The one or more wireless transceiver(s) 125 may send and receive signals over the wireless WAN 255. The one or more wireless transceivers 125 may comprise a multi-band cellular transceiver that supports multiple radio frequency bands. The vehicle control system 150 may use the wireless WAN 255 to access a server 270, such as a driving assist server, via one or more communications networks 260, such as the Internet. The server 270 may be implemented as one or more server modules in a data center and is typically located behind a firewall 265. The server 270 may be connected to network resources 275, such as supplemental data sources that may provide information to be used by the vehicle control system 150.

The wireless transceiver(s) 125 may also comprise a wireless local area network (WLAN) transceiver for communicating with a WLAN (not shown) via a WLAN access point (AP). The WLAN may comprise a Wi-Fi wireless network which conforms to IEEE 802.11x standards (sometimes referred to as Wi-Fi®) or other communication protocol. The wireless transceiver(s) 125 may also comprise a short-range wireless transceiver, such as a Bluetooth® transceiver, for communicating with a mobile computing device, such as a smartphone or tablet. The wireless transceiver(s) 125 may also comprise other short-range wireless transceivers including but not limited to Near field communication (NFC), IEEE 802.15.3a (also referred to as UltraWideband (UWB)), Z-Wave, ZigBee, ANT/ANT+ or infrared (e.g., Infrared Data Association (IrDA) communication), among other possibilities.

The communication system 250 also includes a satellite network 280 comprising a plurality of satellites. The vehicle control system 150 may use signals received from the plurality of satellites in the satellite network 280 to determine its position. The satellite network 280 typically comprises a plurality of satellites which are part of at least one Global Navigation Satellite System (GNSS) that provides autonomous geo-spatial positioning with global coverage. For example, the satellite network 280 may be a constellation of GNSS satellites.

FIG. 1B illustrates selected components of the vehicle 105 in accordance with some examples described herein. The vehicle 105 can include a sensor system 110, a perception system 130, a planning system 140, the vehicle control system 150 and an electromechanical system 160, for example. The perception system 130, the planning system 140 and the vehicle control system 150 may be distinct software-enabled systems that are part of an autonomous driving system (ADS) 120 of the vehicle 105, among other possibilities.

The sensor system 110 includes one or more environment sensors 111 for collecting information about an environment 100 surrounding the vehicle 105 as the vehicle 105 operates in the environment 100. The environment sensors 111 can include, for example, one or more camera units 112, one or more light detection and ranging (LiDAR) units 113, and one or more radar units such as synthetic aperture radar (SAR) units 114, among other possibilities. Each type of sensor unit 112, 113, 114, may collect respective different information about the environment 100, and may provide sensor data to the perception system 130 and/or the vehicle control system 150 in respectively different formats. For example, a camera unit 112 may provide camera data representative of a digital image, a LIDAR unit 113 may provide a two or three-dimensional point cloud, and the SAR unit 114 may provide radar data representative of a radar image.

The sensor system 110 includes one or more vehicle sensors 115 for collecting information about the physical operating conditions of the vehicle 105 itself, including, for example, sensors for sensing steering angle, linear speed, linear and angular acceleration, pose (pitch, yaw, roll), compass travel direction, vehicle vibration, throttle state, brake state, wheel traction, transmission gear ratio, cabin temperature and pressure, etc. In examples, the vehicle sensors 115 may include an inertial measurement unit (IMU) 116 that senses the vehicle's 105 specific force and angular rate and that provides data about an orientation of the vehicle based on the sensed specific force and angular rate. The vehicle sensors may also include an electronic compass 117, location data from global positioning system (GPS) sensor 118 and other vehicle sensors 119 such as a speedometer, a tachometer, wheel traction sensor, transmission gear sensor, throttle and brake position sensors, and steering angle sensor. The vehicle control system 150 may also collect information about a position of the vehicle 105 using signals received from the satellite network 260, via a satellite receiver (not shown) and generate positioning data representative of the position of the vehicle 105.

In examples, information collected by the sensor system 110 about the vehicle environment 100 (e.g., surrounding the vehicle 105) is provided as environmental sensor data to the perception system 130 while information collected by the sensor system 110 about the physical operating conditions of the vehicle 105 is provided as vehicle sensor data to the perception system 130. In example embodiments, environmental sensor data (e.g., received from the camera, LiDAR and radar units 112, 113, 114) may be used by perception system 130 (and/or other systems) to determine object instances in the local environment surrounding the vehicle 105 (e.g., any immediately surrounding obstacles, such as cars, pedestrians, traffic lights etc.) as well as information from a wider vicinity. Sensor data from GPS unit 118 and other sensors may be used to determine the vehicle's location, defining a geographic position of the vehicle 105. Vehicle sensor data may be used to determine the vehicle's operating parameters, including speed and pose of the vehicle 105 relative to a frame of reference, among other possibilities.

In some examples, the sensor system 110 or the perception system 120 may also have access to other information (not shown), such as a map or other expert knowledge representing known information about the surrounding environment 100. In examples, the map may be a standard definition (SD) map, where the SD map may be received from an internal or external reference database (e.g., retrieved based on the vehicle's position, as determined using the GPS unit 118, among other possibilities). In examples, expert knowledge may include a set of expert rules.

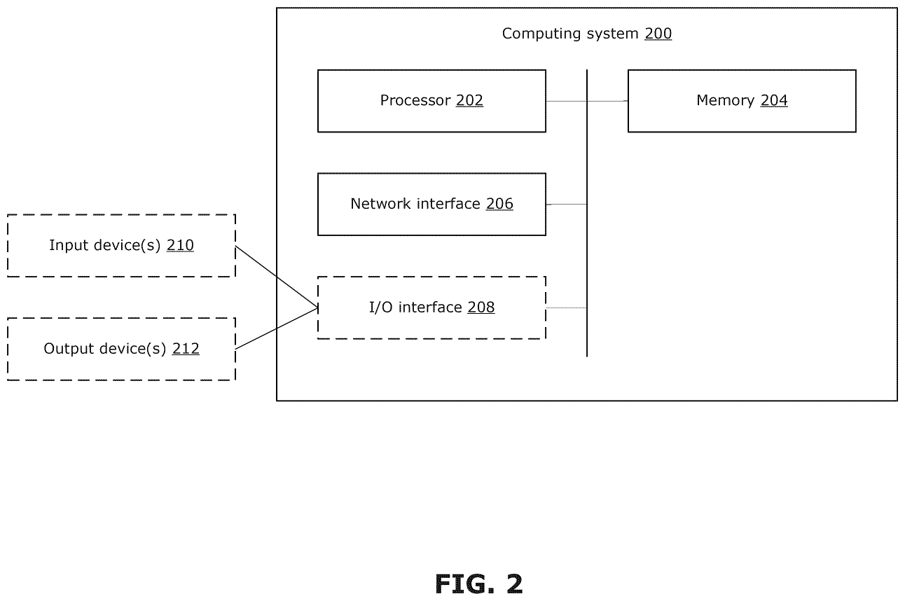

The systems of the vehicle 105 may include or may communicate with a computing system (such as the computing system 200 of FIG. 2), for example, for implementing embodiments of the present disclosure, such as for executing software instructions to implement one or more software systems, software subsystems, and software modules. Generally, it should be understood that software systems, software subsystems, and software modules disclosed herein may be implemented as a set of instructions stored in a memory (e.g., memory 204). For example, the memory 204 may include executable instructions for implementing the perception system 130, the planning system 140 and the vehicle control system 150, among other systems or subsystems. In example embodiments, one or more of the perception system 130, the planning system 140 and the vehicle control system 150 are implemented using respective sets of machine-readable instructions that are executable by one or more processors in the computing system 200 (FIG. 2).

Alternatively, the perception system 130, the planning system 140, and the vehicle control system 150 may be implemented as one or more chips (e.g., application-specific integrated circuit (ASIC), field-programmable gate array (FGPA), and/or other types of system on chip). Accordingly, as used herein, terms such as “system” and “module” can refer to a combination of a hardware processing circuit and machine-readable instructions (software and/or firmware) executable on the hardware processing circuit. A hardware processing circuit can include any or some combination of a microprocessor, a core of a multi-core microprocessor, a microcontroller, a programmable integrated circuit, a programmable gate array, a digital signal processor, or another hardware processing circuit. In some examples, a “system” and a “module” can refer to a suitably configured hardware processing circuit.

In some embodiments, for example, the perception system 130 may be a machine-learning based system that enables the sensing and interpretation of the vehicle environment 100 (e.g., using sensor data received from sensors 110) and the determination of a position and movement of the vehicle 105 within the environment 100 (e.g., localization). In some embodiments, for example, the planning system 140 may be a machine-learning based system that generates a planned path (which may include planned sub-paths and planned behaviors) to be executed by the vehicle 105. In some embodiments, for example one or more processors in the computing system 200 (FIG. 2) of the vehicle 105 may enable the vehicle control system 150 to send control signals to the electromechanical system 160 of the vehicle 105 to operate the electromechanical components (e.g. the steering in the steering unit 162, brakes in the brake unit 164, throttle in the throttle unit 166 of the vehicle 105, among other possibilities).

Various systems and components of the vehicle 105 may communicate with each other, for example, through wired or wireless communication. For example, the sensor system 110 may communicate with the perception system 130 and the vehicle control system 150; the perception system 130 may communicate with the planning system 140 and the vehicle control system 150; the planning system 140 may communicate with the vehicle control system 150; and the vehicle control system 150 may communicate with the electromechanical system 160. Although example flows of data (indicated by arrows) are illustrated in FIG. 1B, it should be understood that data may be communicated among the sensors 110 and systems 130, 140, 150 and 160 in various different ways, and there may be two-way data communication between 110, 130, 140, 150 and 160.

FIG. 2 is a block diagram illustrating a simplified example implementation of a computing system 200 that is suitable for implementing embodiments described herein. In some implementations, computing system 200 can be included in the vehicle 105, or the computing system 200 can be an electronic computing device, such as a networked server (e.g., server 270) or a single computer. In other implementations, the computing system 200 can be a distributed computing system including multiple devices (such as a cloud computing platform) or a virtual machine running on one or more devices in mutual communication over a network. Other examples suitable for implementing implementations described in the present disclosure can be used, which can include components different from those discussed below. Although FIG. 2 shows a single instance of each component, there can be multiple instances of each component in the computing system 200. The computing system 200 may be used to execute instructions for generating an online HD map 370 for use by a vehicle planning system (e.g., planning system 140) or a vehicle control system (e.g., vehicle control system 150) for operating an autonomous vehicle, using any of the examples described above.

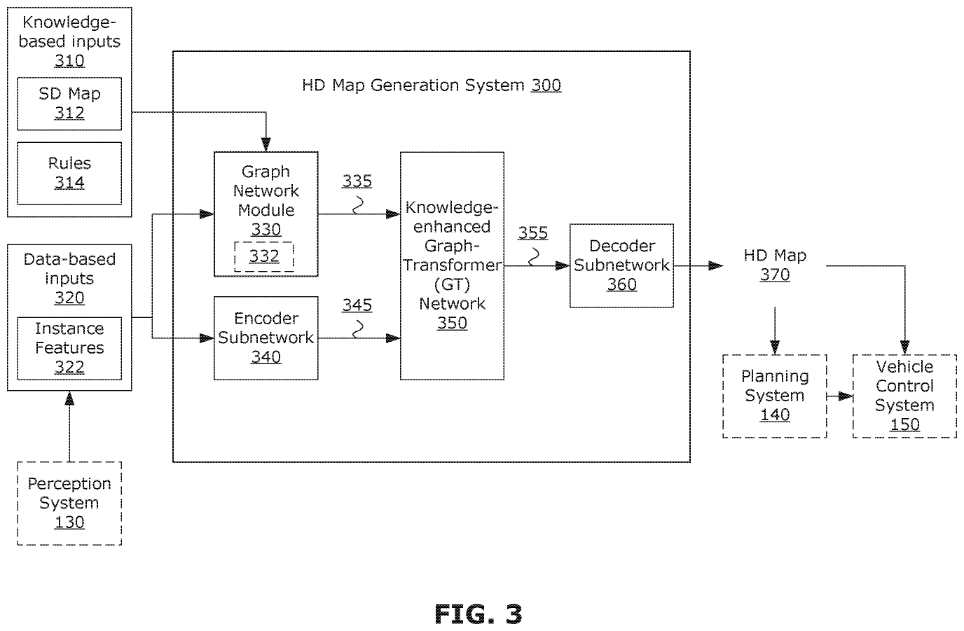

The computing system 200 includes at least one processing unit and at least one physical memory 204. The processing unit may be a hardware processor 202 (simply referred to as processor 202). The processor 202 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 204 may include a volatile or non-volatile memory (e.g., a flash memory, a random access memory (RAM), and/or a read-only memory (ROM)). The memory 204 may store instructions for execution by the processor 202, such as to carry out examples described in the present disclosure. In examples, the memory 204 may store instructions for implementing any of the neural networks and methods disclosed herein. For example, the memory 204 may include instructions, executable by the processor 202, to implement the HD map generation system 300 as described with respect to FIG. 3 below. The memory 204 may include other software instructions, such as for implementing an operating system and other applications/functions. The memory 204 may also include data, such as model training data or trained parameters (e.g., weight values) of a neural network, among other possibilities.

The computing system 200 may include one or more network interfaces (collectively referred to as network interface 206) for wired or wireless communication with a network (e.g., an intranet, the Internet, a P2P network, a WAN and/or a LAN) or another node. The network interface 206 may include wired links (e.g., Ethernet cable) and/or wireless links (e.g., one or more antennas).

The computing system 200 may include an input/output (I/O) interface 208, which may interface with input device(s) 210 and/or output device(s) 212. Input device(s) 210 may include, for example, buttons, a camera, a microphone, a touchscreen, a keyboard, etc. Output device(s) 212 may include, for example, a display, a speaker, etc. In some embodiments, for example, the input device(s) 210 may be sensors 110 of the vehicle 105. In this example, optional input device(s) 210 and optional output device(s) 212 are shown external to the computing system 200. In other examples, one or more of the input device(s) 210 and/or output device(s) 212 may be an internal component of the computing system 200.

In some examples, the computing system 100 may also include an electronic storage unit (not shown), such as a solid state drive, a hard disk drive, a magnetic disk drive and/or an optical disk drive. In some examples, data and/or instructions may be provided by an external memory (e.g., an external drive in wired or wireless communication with the computing system 100) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The components of the computing system 100 may communicate with each other via a bus, for example.

FIG. 3 shows a block diagram of an example architecture for the online HD map generation system 300, in accordance with examples of the present disclosure. For example, the HD map generation system 300 may represent a trained neural network model that has been trained to predict, during an inference phase, a HD map 370. The HD map generation system 300 may be software that is implemented in the computing system 200 of FIG. 2, in which the processor 202 is configured to execute instructions of the HD map generation system 300 stored in the memory 204. The HD map generation system 300 in this example includes a graph network module 330, an encoder subnetwork 340, a knowledge-enhanced graph-transformer (GT) framework 350 and a decoder subnetwork 360. Although 330, 340, 350 and 360 are shown as separate components, it is understood that the functions of each of the components can be performed by a single component, among other possibilities.

In examples, inputs may be provided to the HD map generation system 300 in the form of knowledge-based inputs 310 and data-based inputs 320. In examples, the knowledge-based inputs 310 may include a standard definition (SD) map 312 (e.g., corresponding to the vehicle environment 100, among other possibilities) and a set of defined rules 314 (e.g., generated by experts and describing relational facts or interactions between road elements or other instances in the vehicle environment, for example, based on road topology, orientation of traffic lights, direction of lanes, Euclidean distances etc.), among other possibilities. In examples, the data-based inputs 320 may include instance-level features 322, for example, generated for one or more object instances in the vehicle environment 100 by the perception system 130. For example, sensor data received from the environment sensors 111 and vehicle data received from the vehicle control sensors 115 (and optionally also positioning data collected from the satellite network 280) may be used by the perception system 130 to generate processed data (e.g., observed frames, feature vectors, occupancy grid maps (OGMs), object classifications and bounding boxes, etc.) or other instance information representing features of the environment 100 for each time step. For example, instance information collected by the sensor system 110 about the vehicle environment is provided as environmental sensor data to the perception system 130 and may represent a temporal sequence of observed frames received from one or more sensors, such as camera 112, LiDAR 113 or SAR 114, among other possibilities. In examples, the instance information may represent spatial information, for example, where each frame represents an image or a point cloud, among other possibilities. In examples, the perception system 130 may process environmental sensor data, for example, the perception system 130 may perform instance segmentation using the received environmental sensor data, for distinguishing between different instances of the same object class in the vehicle environment 100 (e.g. distinguishing different cars in an image), among other possibilities. In examples, the perception system 130 may extract features associated with each object instance as instance features 322, for providing to the HD map generation system 300. For example, the perception system 130 may include one or more machine-learning based systems (e.g., trained neural networks) that generate processed data that represent features of the environment 100 for each time step (e.g., instance features 322).

In examples, the graph network module 330 receives the knowledge-based inputs 310 and the data-based inputs 320 and generates an initial graph 335. In examples, the initial graph 335, denoted as G=(V, E), comprises a plurality of nodes V representing road elements available in the SD map 312 (e.g., identified by the perception system 130 and corresponding to the vehicle environment 100, where V={v₁, v₂, . . . , vₙ} and n is the number of nodes) and a plurality of edges E representing connections between those instances. In examples, each edge corresponds to a respective relationship between two associated nodes that are connected by the edge. In examples, the initial graph 335 may be assembled using the information included in the SD map 312 (e.g., providing road-level topology information) and the rules 314, to generate and connect nodes in the initial graph 335 with a coarse level of accuracy, for example, such that that topological relationships between road elements are maintained. In examples, the rules 314 may be used to broadly define connections between nodes or prevent connections between nodes, for example, by defining or describing criteria for connecting two nodes with an edge, among other possibilities. In an exemplary embodiment, rules 314 may indicate that two road elements can be connected by an edge if they correspond to a pre-determined threshold distance and are oriented along a same direction, for example, where a pre-determined threshold can include a distance (e.g., Euclidean distance), an orientation angle, etc. In examples, instance features 322 may also inform the generation of the initial graph 335, for example, serving as initial node features for object instances (e.g., corresponding to road elements) in the initial graph 335. In examples, the initial graph 335 may be provided as input to the knowledge-enhanced graph-transformer (GT) framework 350, which incorporates at least one GNN channel and/or layer in its architecture. During a training process, for example, the initial node features may be updated, for example, the initial graph 335 may be used by the at least one GNN channel and/or layer to enable message passing between neighboring nodes connected by edges, thereby introducing structural biases in representation learning. In this regard, incorporating prior knowledge in the form of topological relationships and simple rules into the HD map generation system 300 may help to improve the accuracy of reconstructed HD maps.

In some embodiments, for example, the initial graph 335 may be generated by modeling a probability distribution of road topology information using a Bayesian probabilistic model. In examples, while the nodes of the initial graph 335 may be deterministic (e.g., derived via the perception system 130, among other possibilities), the edges of the initial graph 335 may be computed using a sampling-based method (e.g., sampled from the road topology data based on probability distributions associated with rule-based criteria). For example, when the rules 314 describe edge criteria (e.g., Euclidean distance between road elements, difference in orientation angle between road elements, etc.), the construction of the initial graph 335 may be sensitive to the chosen edge criteria thresholds. In examples, a probability distribution corresponding to the edge criteria may be generated from labeled data (e.g., training data including edge connection labels, among other possibilities). Threshold values for the edge criteria may be sampled from the distribution and applied to the rules 314, for example, for determining edge connections in the initial graph 335. In this way, multiple initial graphs 335 may be generated (e.g., using the sampled threshold values) and provided as input to the HD map generation system 300, thereby producing multiple corresponding outputs (e.g., intermediate HD maps). In examples, a final HD map (e.g., HD map 370) may be generated from the multiple intermediate HD maps, for example, using an ensemble method (e.g., majority voting, among other possibilities). In this regard, incorporating various possibilities for the initial graph 335 using a sampling-based approach may mitigate the impact of inaccurate initial graph structure on the accuracy of final reconstructed HD maps.

In examples, the encoder subnetwork 340 receives the data-based inputs 320 and generates instance embeddings 345. In examples, the encoder subnetwork 340 (which may be a neural network) may be configured to convert or transform input data (e.g. instance features 322 extracted from data corresponding to the vehicle environment 100, such as images, point clouds etc.) into a sequence of representations (otherwise referred to as embeddings) having a defined format, such as a vector of fixed length. In examples, the instance embeddings 345 may represent embedding vectors having reduced dimensionality compared to the input data. In examples, the instance features 322 may represent feature vectors corresponding to one or more object instances (e.g., corresponding to road elements, and detected by environment sensors, among other possibilities) in the vehicle environment 100, where the feature vectors represent encoded features of each object instance.

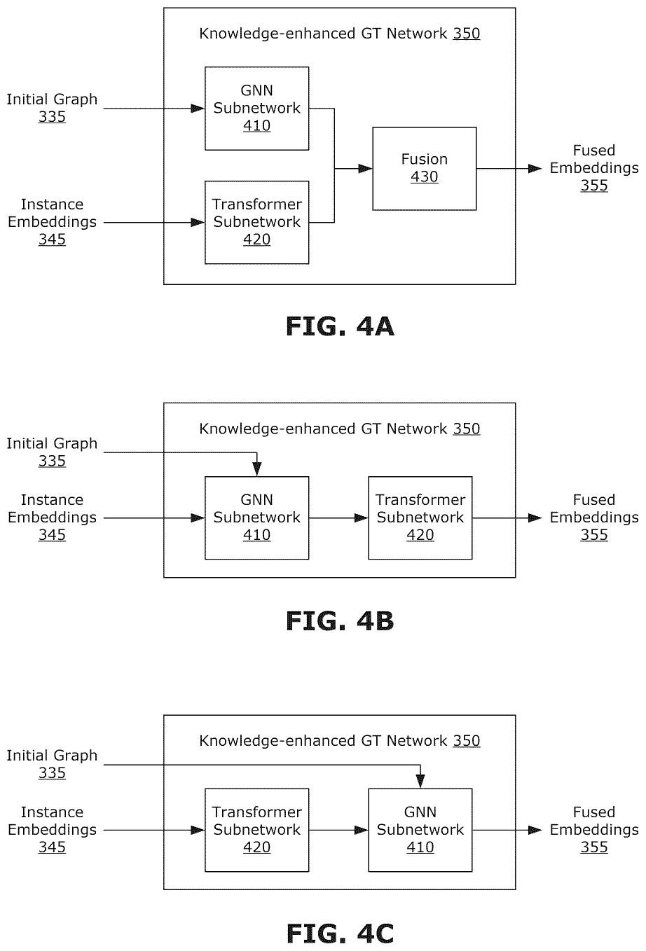

In examples, the knowledge-enhanced GT network 350 may receive the initial graph 335 and the instance embeddings 345 and may generate fused embeddings 355. In examples, the knowledge-enhanced GT network 350 may represent a graph-transformer framework, where the architecture of the knowledge-enhanced GT network 350 may include one or more GNN layers and one or more transformer layers (as described in further detail with respect to FIGS. 4A-4C below). In examples, the knowledge-enhanced GT network 350 may be trained using deep learning techniques to receive the initial graph 335 and the instance embeddings 345 as input, and output fused embeddings 355, where the fused embeddings 355 correspond to one or more object instances in the vehicle environment 100.

FIG. 4A is a block diagram illustrating an example architecture of the knowledge-enhanced GT network 350 that may be used to implement methods to generate a HD map 370, in accordance with examples of the present disclosure. The knowledge-enhanced GT network 350 of FIG. 4A includes a GNN subnetwork 410 and a transformer subnetwork 420 configured in parallel, and a fusion block 430.

In examples, the GNN subnetwork 410 receives and processes the initial graph 335 to generate a set of node embeddings representative of a fully connected graph. For example, the initial graph 335 may be processed by N GNN layers (N>=1) of the GNN subnetwork 410 to allow information interaction and/or message passing between neighboring nodes. In examples, the GNN subnetwork 410 may represent a GNN which has been trained using deep learning techniques to learn a representation of each node in a graph (e.g., a node embedding), where each node embedding also encodes information about relationships between neighboring nodes, or features of neighboring nodes, among other possibilities.

In examples, the transformer subnetwork 420 receives and processes the instance embeddings 345 to generate updated instance embeddings. In examples, the transformer subnetwork 420 may represent a neural network (e.g., including a self-attention module and a feed-forward network, among other possibilities) which has been trained using deep learning techniques to learn a representation of each instance, where the self-attention module facilitates interactions across all instance embeddings 345. For example, the instance embeddings 345 may be transformed by M transformer layers (M>=1) of the transformer subnetwork 420, where each instance can attend to the embeddings of all other instances through the attention-based mechanism.

In examples, the node embeddings and the updated instance embeddings may be provided to the fusion block 430 for generating fused embeddings 355. For example, the fusion block 430 may perform element-wise summation on the node embeddings and the updated instance embeddings or another approach may be used to fuse the node embeddings and the updated instance embeddings. In examples, the knowledge-enhanced GT network 350 may repeat this process K times (K>=1) before passing the fused embeddings 355 to the decoder subnetwork 360 of the HD map generation system 300 for HD map construction.

FIG. 4B is a block diagram illustrating an example architecture of the knowledge-enhanced GT network 350 that may be used to implement methods to generate a HD map 370, in accordance with examples of the present disclosure. The knowledge-enhanced GT network 350 of FIG. 4B includes a GNN subnetwork 410 and a transformer subnetwork 420 configured in series.

In examples, the GNN subnetwork 410 receives and processes the initial graph 335 and the instance embeddings 345 to generate a set of node embeddings representative of a fully connected graph. For example, the initial graph 335 and the instance embeddings 345 may be processed by N GNN layers (N>=1) of the GNN subnetwork 410 to allow information interaction and/or message passing between neighboring nodes/instances (where each node in the initial graph 335 corresponds to an object instance). In examples, the GNN subnetwork 410 may represent a GNN which has been trained using deep learning techniques to learn a representation of each node/instance in a graph (e.g., a node embedding), where each node embedding also encodes information about relationships between neighboring nodes, or features of neighboring nodes, among other possibilities.

In examples, the transformer subnetwork 420 receives and processes the node embeddings to generate fused embeddings 355. In examples, the transformer subnetwork 420 may represent a neural network (e.g., including a self-attention module and a feed-forward network, among other possibilities) which has been trained using deep learning techniques to learn a representation of each instance, where the self-attention module facilitates interactions across all node embeddings. For example, the received node embeddings may be transformed by M transformer layers (M>=1) of the transformer subnetwork 420, where each instance can attend to the embeddings of all other instances through the attention-based mechanism.

In examples, the knowledge-enhanced GT network 350 may repeat this process K times (K>=1) before passing the fused embeddings 355 to the decoder subnetwork 360 of the HD map generation system 300 for HD map construction.

FIG. 4C is a block diagram illustrating an example architecture of the knowledge-enhanced GT network 350 that may be used to implement methods to generate a HD map 370, in accordance with examples of the present disclosure. The knowledge-enhanced GT network 350 of FIG. 4C includes a transformer subnetwork 420 and a GNN subnetwork 410 configured in series.

In examples, the transformer subnetwork 420 receives and processes the instance embeddings 345 to generate updated instance embeddings. In examples, the transformer subnetwork 420 may represent a neural network (e.g., including a self-attention module and a feed-forward network, among other possibilities) which has been trained using deep learning techniques to learn a representation of each instance, where the self-attention module facilitates interactions across all instance embeddings 345. For example, the received node embeddings may be transformed by M transformer layers (M>=1) of the transformer subnetwork 420, where each instance can attend to the embeddings of all other instances through the attention-based mechanism.

In examples, the GNN subnetwork 410 receives and processes the initial graph 335 and the updated instance embeddings to generate fused embeddings 355 (where fused embeddings 355 may represent a set of node embeddings representative of a fully connected graph). For example, the initial graph 335 and the updated instance embeddings may be processed by N GNN layers (N>=1) of the GNN subnetwork 410 to allow information interaction and/or message passing between neighboring nodes/instances (where each node in the initial graph 335 corresponds to an object instance). In examples, the GNN subnetwork 410 may represent a GNN which has been trained using deep learning techniques to learn a representation of each node/instance in a graph (e.g., a node embedding), where each node embedding also encodes information about relationships between neighboring nodes/instances, or features of neighboring nodes/instances, among other possibilities.

In examples, the knowledge-enhanced GT network 350 may repeat this process K times (K>=1) before passing the fused embeddings 355 to the decoder subnetwork 360 of the HD map generation system 300 for HD map construction

Returning to FIG. 3, the decoder subnetwork 360 may receive the fused embeddings 355 and may predict the edge connections in the graph network (e.g., between pairs of object instances represented by pairs of fused embeddings 355) to construct the HD map 370. In examples, the decoder subnetwork 360 may include one or more neural networks (e.g., feedforward neural networks, such as a multilayer perceptron (MLP), among other possibilities) for processing the fused embeddings 355. In examples, pairs of fused embeddings 355 may be processed and compared, for example, using a vector similarity measure (e.g., dot product, among other possibilities) and the decoder subnetwork 360 may predict the edge connections based on the comparison (e.g., using a binary classification approach). For example, an edge connection may be predicted for a pair of fused embeddings 355 based on a predefined threshold value (e.g., where a prediction probability above the threshold value indicates an edge connection between the pair of fused embeddings 355, and a prediction probability below the threshold value indicates an absence of an edge connection between the pair of fused embeddings 355). In some embodiments, for example, the fused embeddings 355 may represent one or more classes of object instances in the vehicle environment 100 (e.g., road embeddings, lane embeddings, traffic light embeddings etc.) and the decoder subnetwork 360 may assemble the HD map 370 based on corresponding road element instances captured by the perception system 130 and/or corresponding to the SD map 312, and the predicted edge connections.

For example, the decoder subnetwork 360 may be configured to generate, in real-time, rasterized HD birds-eye-view (BEV) maps (also referred to top-down view maps) that represent observed scenes in the vicinity of vehicle 105 from a 2-dimensional birds eye perspective, among other possibilities. For example, the HD map 370 may include a vector map such as a road network map including a georeferenced position of the vehicle 105 and objects in the environment 100 (e.g., roads, lanes, traffic lights, traffic signs, pedestrians etc.), for example, using points, lines, polygons etc. In other examples, the decoder may be configured to generate, in real-time, rasterized HD 3D maps that represent observed scenes in the vicinity of vehicle 105 from a 3-dimensional perspective, among other possibilities. For example, the HD map 370 may include a point cloud map where a 3D shape of objects is represented by points, among other possibilities.

In examples, the HD map 370 may be provided to a controller of the vehicle 105, to cause the controller to automatically control an action of the autonomous vehicle, based on the HD map 370. For example, the HD map 370 may be provided to the planning system 140 or the vehicle control system 150, among other possibilities, where the planning system 140 may use the HD map 370 to plan a trajectory of the vehicle 105, or where the vehicle control system 150 may use the HD map 370 to operate the vehicle along the planned trajectory, among other possibilities.

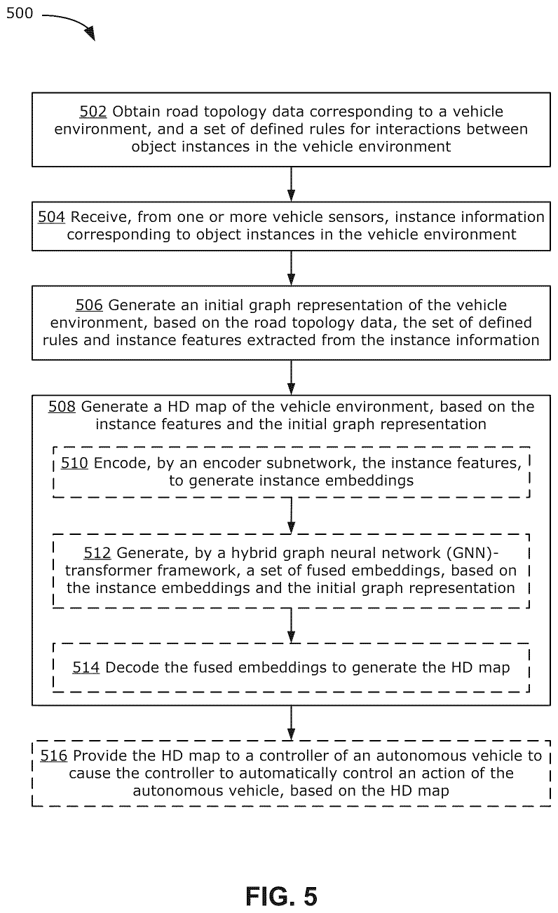

FIG. 5 is a flowchart illustrating an example method 500 for generating a high definition (HD) map 370 of a vehicle environment 100, in accordance with examples of the present disclosure. The method 500 may be performed by the computing system 200. For example, the processor 202 may execute computer readable instructions (which may be stored in the memory 204) to cause the computing system 200 to perform the method 500.

Method 500 begins with step 502, in which road topology data corresponding to the vehicle environment, and a set of expert rules for describing interactions between road elements in the vehicle environment 100 is obtained.

At step 504, instance information corresponding to object instances in the vehicle environment 100 is received. In examples, the instance information may represent a temporal sequence of observed frames received from one or more sensors, such as camera 112, LiDAR 113 or SAR 114, among other possibilities. In examples, the instance information may represent spatial information, for example, where each frame represents an image or a point cloud, among other possibilities.

At step 506, an initial graph representation 335 of the vehicle environment 100 is generated based on the road topology data, the set of expert rules and instance features extracted from the instance information. In some examples, the initial graph representation may be generated by assembling a graph network comprising a plurality of nodes and a plurality of edges connecting the nodes, wherein each node in the graph network corresponds to a respective object instance in the vehicle environment and each edge in the graph network represents a relationship between two associated nodes that are connected by the edge.

At step 508, the HD map 370 is generated based on the instance features 322 and the initial graph representation 335. In some embodiments, for example, for generating the HD map 370 the following operations 510-514 may be performed.

At step 510, the instance features 322 may be encoded to generate instance embeddings 345. At step 512, a set of fused embeddings 355 may be generated, based on the instance embeddings 345 and the initial graph representation 335. For example, the instance embeddings 345 and the initial graph representation 335 may be input to the knowledge-enhanced GT network 350 for generating the fused embeddings 355. At step 514, the fused embeddings 355 may be decoded to generate the HD map 370.

At step 516, the HD map 370 may be provided to a controller of an autonomous vehicle to cause the controller to automatically control an action of the autonomous vehicle, based on the HD map 370. In examples, the HD map 370 may be provided to the planning system 140 or the vehicle control system 150 associated with an autonomous vehicle and the planning system 140 or the vehicle control system 150 may automatically control the action, based on the HD map 370. For example, the vehicle control system 150 may cooperate with the electromechanical system 160 of the autonomous vehicle to execute actions to operate the autonomous vehicle in the vehicle environment 100, among other possibilities.

Some examples of the present disclosure are described in the context of autonomous vehicles. Although examples described herein may refer to a car as the autonomous vehicle, the teachings of the present disclosure may be implemented in other forms of autonomous or semi-autonomous vehicles including, for example, trams, subways, trucks, buses, surface and submersible watercraft and ships, aircraft, drones (also called unmanned aerial vehicles (UAVs)), warehouse equipment, manufacturing facility equipment, construction equipment, farm equipment, autonomous service robots such as vacuum cleaners and lawn mowers, and other robotic devices. Autonomous vehicles may include vehicles that do not carry passengers as well as vehicles that do carry passengers.

It should be understood that the listing of example domains provided is non-exhaustive and should not be considered to be limiting. In some embodiments, for example, the disclosed solution may be applied to tasks executed within domains in which rich domain knowledge that can be represented as graphs, such as protein interaction network construction, among other possibilities. For example, knowledge of interactions between some proteins can be used to construct an initial graph 335 to be provided to the knowledge-enhanced GT network 350, for enhancing performance of the network compared to a strictly transformer-based network.

In some embodiments, for example, prior knowledge may be introduced to the knowledge-enhanced GT network 350 through inputs other than graphs. For example, prior knowledge may be introduced to the knowledge-enhanced GT network 350 by adding additional global nodes for transformer layers or adding bias terms to node and/or edge features, among other possibilities.

Various embodiments of the present disclosure having been thus described in detail by way of example, it will be apparent to those skilled in the art that variations and modifications may be made without departing from the disclosure. The disclosure includes all such variations and modifications as fall within the scope of the appended claims.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration in-formation, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer-implemented method comprising:
obtaining road topology data corresponding to a vehicle environment, and a set of defined rules for interactions between road elements in the vehicle environment;
receiving, from one or more vehicle sensors, instance information corresponding to object instances in the vehicle environment;
generating at least one initial graph representation of the vehicle environment, based on the road topology data, the set of defined rules and instance features extracted from the instance information;
generating a high-definition (HD) map of the vehicle environment, based on the instance features and the at least one initial graph representation; and
providing the HD map to a controller of an autonomous vehicle, to cause the controller to automatically control an action of the autonomous vehicle, based on the HD map.

2. The method of claim 1, wherein generating the HD map comprises:
encoding, by an encoder subnetwork, the instance features, to generate instance embeddings;
generating, by a hybrid graph-transformer (GT) network, a set of fused embeddings, based on the instance embeddings and the at least one initial graph representation, the hybrid GT network including a graph neural network (GNN) subnetwork and a transformer subnetwork; and
decoding the fused embeddings to generate the HD map.

3. The method of claim 2, wherein generating the set of fused embeddings comprises:
processing, by the GNN subnetwork, the at least one initial graph representation to generate initial graph embeddings; and
processing, by the transformer subnetwork, the instance embeddings to generate updated instance embeddings,
wherein the fused embeddings are generated by fusing the initial graph embeddings and the updated instance embeddings.

4. The method of claim 2, wherein generating the set of fused embeddings comprises:
processing, by the GNN subnetwork, the initial graph representation and the instance embeddings to generate updated instance embeddings; and
processing, by the transformer subnetwork, the updated instance embeddings to generate the fused embeddings.

5. The method of claim 2, wherein generating the set of fused embeddings comprises:
processing, by the transformer subnetwork, the instance embeddings to generate updated instance embeddings; and
processing, by the GNN subnetwork, the updated instance embeddings and the initial graph representation, to generate the fused embeddings.

6. The method of claim 2, wherein the GNN subnetwork includes a relational graph convolutional network (RGCN) and the transformer subnetwork includes an attention mechanism.

7. The method of claim 1, wherein generating the at least one initial graph representation comprises:
assembling at least one graph network comprising a plurality of nodes and a plurality of edges connecting the nodes, each node corresponding to a respective object instance in the vehicle environment and each edge representing a relationship between two associated nodes that are connected by the edge.

8. The method of claim 7, wherein the at least one initial graph representation comprises multiple different initial graph representations, the method further comprising:
modeling, using a Bayesian probabilistic model, a probability distribution associated with one or more edge connection criteria of the road topology data; and
for each of the multiple different initial graph representations:
assembling a respective candidate graph network by:
sampling one or more threshold values from the probability distribution; and
determining edge connections between nodes in the candidate graph network, based on the sampled threshold values; and,
generating a corresponding intermediate HD map, based on the instance features and the respective candidate graph network,
wherein the HD map of the vehicle environment is a final HD map generated by aggregating the multiple intermediate HD maps using an ensemble method.

9. The method of claim 1, wherein the road topology data includes a standard definition map of the vehicle environment.

10. (canceled)

11. A system comprising:
one or more processors; and
a memory storing machine-executable instructions which, when executed by the one or more processors, cause the system to:
obtain road topology data corresponding to a vehicle environment, and a set of defined rules for interactions between road elements in the vehicle environment;
receive, from one or more vehicle sensors, instance information corresponding to object instances in the vehicle environment;
generate at least one initial graph representation of the vehicle environment, based on the road topology data, the set of defined rules and instance features extracted from the instance information;
generate a high-definition (HD) map of the vehicle environment, based on the instance features and the at least one initial graph representation; and
provide the HD map to a controller of an autonomous vehicle, to cause the controller to automatically control an action of the autonomous vehicle, based on the HD map.

12. The system of claim 11, wherein the machine-executable instructions, when executed by the one or more processors to generate the HD map, further cause the system to:
encode, by an encoder subnetwork, the instance features, to generate instance embeddings;
generate, by a hybrid graph-transformer (GT) network, a set of fused embeddings, based on the instance embeddings and the at least one initial graph representation, the hybrid GT network including a graph neural network (GNN) subnetwork and a transformer subnetwork; and
decode the fused embeddings to generate the HD map.

13. The system of claim 12, wherein the machine-executable instructions, when executed by the one or more processors to generate the set of fused embeddings, further cause the system to:
process, by the GNN subnetwork, the at least one initial graph representation to generate initial graph embeddings; and
process, by the transformer subnetwork, the instance embeddings to generate updated instance embeddings,
wherein the fused embeddings, are generated by fusing the initial graph embeddings and the updated instance embeddings.

14. The system of claim 12, wherein the machine-executable instructions, when executed by the one or more processors to generate the set of fused embeddings, further cause the system to:
process, by the GNN subnetwork, the initial graph representation and the instance embeddings to generate updated instance embeddings; and
process, by the transformer subnetwork, the updated instance embeddings to generate the fused embeddings.

15. The system of claim 12, wherein the machine-executable instructions, when executed by the one or more processors to generate the set of fused embeddings, further cause the system to:
process, by the transformer subnetwork, the instance embeddings to generate updated instance embeddings; and
process, by the GNN subnetwork, the updated instance embeddings and the initial graph representation, to generate the fused embeddings.

16. The system of claim 12, wherein the GNN subnetwork includes a relational graph convolutional network (RGCN) and the transformer subnetwork includes an attention mechanism.

17. The system of claim 11, wherein the machine-executable instructions, when executed by the one or more processors to generate the initial graph representation, further cause the system to:
assemble at least one graph network comprising a plurality of nodes and a plurality of edges connecting the nodes, each node corresponding to a respective object instance in the vehicle environment and each edge representing a relationship between two associated nodes that are connected by the edge.

18. The system of claim 17, wherein the at least one initial graph representation comprises multiple different initial graph representations, wherein the machine-executable instructions, when executed by the one or more processors, further cause the system to:
model, using a Bayesian probabilistic model, a probability distribution associated with one or more edge connection criteria of the road topology data; and
for each of the multiple different initial graph representations:
assemble a respective candidate graph network by:
sampling one or more threshold values from the probability distribution; and
determining edge connections between nodes in the candidate graph network, based on the sampled threshold values; and,
generate a corresponding intermediate HD map, based on the instance features and the respective candidate graph network,
wherein the HD map of the vehicle environment is a final HD map generated by aggregating the multiple intermediate HD maps using an ensemble method.

19. The system of claim 11, wherein the road topology data includes a standard definition map of the vehicle environment.

20. A non-transitory computer-readable medium having machine-executable instructions stored thereon, the machine-executable instructions, when executed by a processor of a device, cause the device to:
obtain road topology data corresponding to a vehicle environment, and a set of defined rules for interactions between road elements in the vehicle environment;
receive, from one or more vehicle sensors, instance information corresponding to object instances in the vehicle environment;
generate at least one initial graph representation of the vehicle environment, based on the road topology data, the set of defined rules and instance features extracted from the instance information;
generate a high-definition (HD) map of the vehicle environment, based on the instance features and the at least one initial graph representation; and
provide the HD map to a controller of an autonomous vehicle, to cause the controller to automatically control an action of the autonomous vehicle, based on the HD map.
